(19) United States
(12) Patent Application Publication
(10) Pub. No.: US 2006/0252416 A1
(43) Pub. Date: Nov. 9, 2006

(54) Method and system for multi-hop communication management in wireless communications networks

(76) Inventors: Yonggang Du, Shanghai (CN); Li Sun, Shanghai (CN); Ni Ma, Shanghai (CN); Neil Christopher Bird, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,310

(22) PCT Filed: Mar. 29, 2004
(86) PCT No.: PCT/IB04/50352

§ 371 Date: Sep. 28, 2005

(30) Foreign Application Priority Data
Apr. 1, 2003 (CN) 03109022.2

(51) Int. Cl. H04Q 7/20

(52) U.S. Cl. 455/422.1

(57) ABSTRACT

The present invention provides a wireless communication system capable of managing multi-hop communications. In one embodiment, upon receiving a request from a mobile terminal for initiating a call, the system determines whether the mobile terminal can use multi-hop communication services and its operating mode for multi-hop communication. The system also determines whether relaying can be provided by other mobile terminals. Then, the system will establish multi-hop communication between the mobile terminal and the system based on the operating mode of the mobile terminal. In a default mode, multi-hop communication can be established without the user's knowledge. In a prompt mode, however, the system sends a prompt to the mobile terminal for selection of the multi-hop communication services, along with information about incentives for using the services. After the multi-hop communication is completed, the system records information relating to the multi-hop communication services for the originating and relaying mobile terminals in the HLR/VLR.

### BACKGROUND OF THE INVENTION

The invention relates generally to wireless communications systems, and more particularly to method and system for multi-hop communication management in wireless communication networks.

Wireless communication networks become increasingly popular nowadays for their provision of ubiquitous computing capability and information access regardless of the location. Currently, there are two types of wireless communication networks: infrastructure-based wireless communication networks, such as cellular phone networks, and infrastructure-less wireless communication networks, such as ad hoc wireless communication networks. In the infrastructure-based networks, the transmission range of a base station or an access point determines the size of a cell, and a mobile terminal within the cell can communicate directly with the base station or access point (in one hop). On the other hand, in the ad hoc wireless communication networks, the mobile terminals are self-organized and can communicate with each other even when they are out of the radio range of the base station or access point, provided they can reach each other via intermediate mobile terminals that forward the data from the source terminal to the destination terminal (in multi-hop). With their intrinsic characteristics, the ad hoc wireless communication networks have many potential applications, such as in personal area networks, military environment and search-and-rescue operations. However, large, pure ad hoc wireless communication networks are still far from deployment due to various technical and human limitations, while the infrastructure-based wireless communication networks are already a huge success.

With the advantages of multi-hop communication capability offered by the ad hoc wireless communication networks, the integration of multi-hop capability in conventional infrastructure-based wireless communication networks is a promising architecture upgrade that will help fulfill, to a large extent, the requirements of the very ambitious capacity, throughput, and coverage of the future wireless communication networks.

An infrastructure-based, multi-hop enabled wireless communication network provides many advantages. With relaying provided by one or more mobile terminals near a cell border, the cell coverage can be further extended. Moreover, relaying can improve signal quality when line-of-sight link is not available and can reduce dead spots, which is particularly important in emergency situations. In addition, since research shows the system capacity is inverse proportional to the total transmission power and the transmission power is inverse proportional to the transmission distance to the n^{th} power, an increase in the number of hops between the source and destination will result in a decrease in the interference and thus an increase in the system capacity.

In recent years, various infrastructure-based, multi-hop enabled wireless communication networks, such as the Opportunity Driven Multiple Access (ODMA) concept in 3 GPP, and the coverage extension for HIPERLAN2 through multi-hop, etc., have been proposed. However, the multi-hop technology is far from being practically deployed because of many challenges, especially the lack of a feasible multi-hop communication management scheme to attract the attention of both mobile operators and mobile users.

Therefore, there is a need for an effective scheme for managing multi-hop communications in infrastructure-based wireless communication networks.

### SUMMARY OF THE INVENTION

The present invention provides an effective scheme for managing multi-hop communications in infrastructure-based wireless communication networks.

According to one embodiment of the invention, a wireless communication system capable of managing multi-hop communications is provided. In this embodiment, upon receiving a request from an originating mobile terminal for initiating a call to a receiving mobile terminal, the system determines whether the originating mobile terminal can use multi-hop communication services and an operating mode of the originating mobile terminal for multi-hop communication. The system also determines whether relaying can be provided by one or more relaying mobile terminals for multi-hop communication by the originating mobile terminal. If the originating mobile terminal can use the multi-hop communication services, the originating mobile terminal is in the default mode, and the relaying can be provided, the system establishes multi-hop communication between the originating mobile terminal and the system. On the other hand, if the originating mobile terminal is in a prompt mode for multi-hop communication, the system sends a prompt to the originating mobile terminal for selection of the multi-hop communication services, along with information about incentives for using the services. If it selects the multi-hop communication services, the system allocates resources for setting up a multi-hop communication link between the originating mobile terminal and the system.

After the multi-hop communication is completed, the system records information relating to the multi-hop communication services for the originating and relaying mobile terminals in at least one of a home location register and a visitor location register. The system also sends discounted billing information to the originating mobile terminal and incentive information to the relaying mobile terminals.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows an overview of multi-hop communication in an infrastructure-based, multi-hop enabled wireless communication network, according to one embodiment of the invention;

FIG. 2 illustrates a process performed by a wireless communication network for managing multi-hop communications, according to one embodiment of the invention;

FIG. 3 illustrates a process performed by a mobile terminal for providing relaying to another mobile terminal in multi-hop communication, according to one embodiment of the invention; and

FIG. 4 illustrates basic components of a mobile terminal in accordance with one embodiment of the invention.

Throughout the drawings, the same reference numerals indicate similar or corresponding features or functions.

### DETAILED DESCRIPTION OF THE PREFERRED EMBODIMENTS

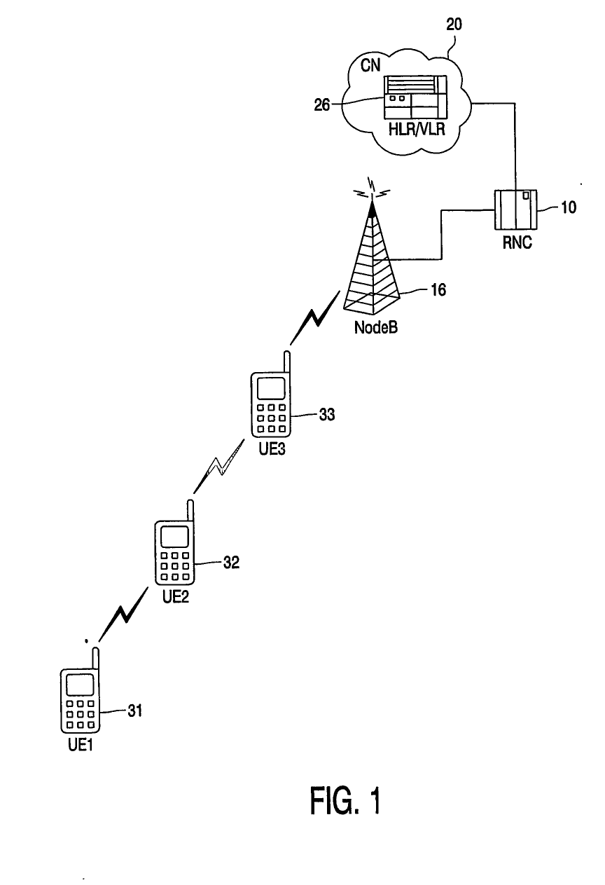

FIG. 1 shows an overview of multi-hop communication in an infrastructure-based, multi-hop enabled wireless communication network (e.g., a Universal Terrestrial Radio Access Network (UTRAN) and a 3 GPP core network), according to one embodiment of the invention. The UTRAN comprises a radio network controller (RNC) 10 responsible for radio resource allocation and management and a Node B 16, which is a base station transceiver. The UTRAN is connected to a core network (CN) 20, which is responsible for high layer signaling and data interaction. Home Location Register (HLR) and Visitor Location Register (VLR) 26 typically located in CN 20 are responsible for recording information about mobile users and related services.

A mobile terminal 31 or user equipment UE1 communicates with Node B 16 with the relaying provided by mobile terminals 32 and 33 (UE2 and UE3). In this example, the direct link between the source and destination is broken into 3 hops. Therefore, 3 radio resource units are needed to maintain the basic communication between UE1 and Node B 16. More detailed descriptions of the multi-hop communication in an infrastructure-based wireless communication network are provided in an article entitled “Self-organisation in Future Mobile Communications” by A. G. Spilling, A. R. Nix, M. A. Beach and T. J. Harrold, published by Electronic and Communication Engineering Journal in June 2000, and also in an article entitled “Intelligent Relaying for Future Personal Communication Systems” by T. J. Harrold and A. R. Nix, published by the Institution of Electrical Engineers (IEE) in 2000. The disclosures of these two articles are hereby incorporated by reference.

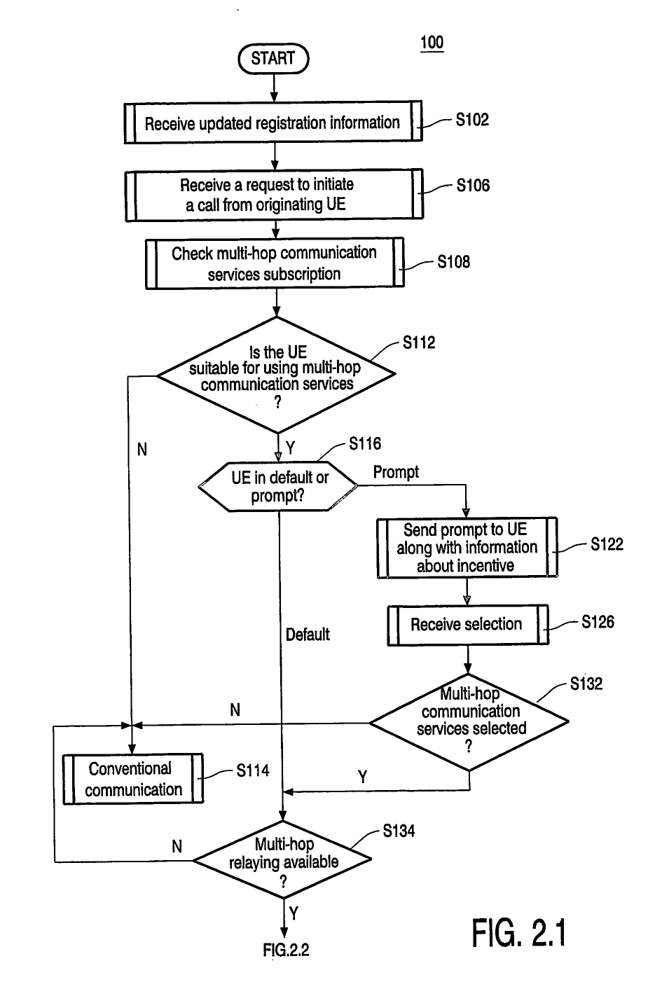

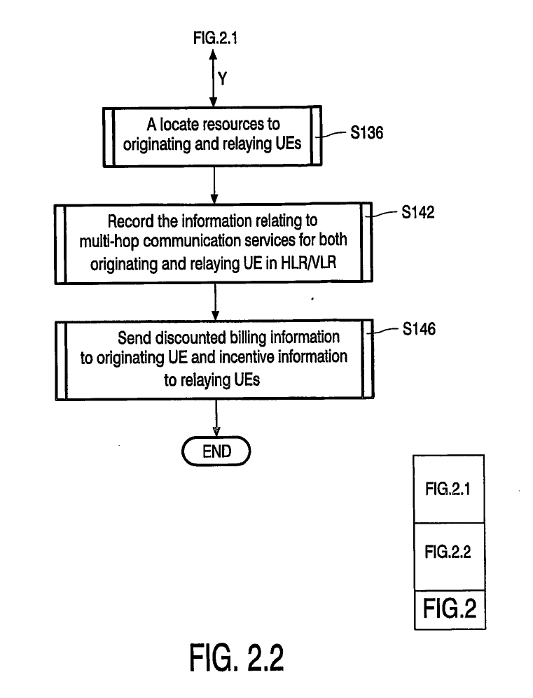

FIG. 2 illustrates a process 100 performed by a wireless communication system, e.g., a UTRAN, for managing multi-hop communications, according to one embodiment of the invention. The various steps of process 100 are preferably implemented with software modules.

After a user has switched on a UE, the UE searches in a cell for signals from the UTRAN, via a Broadcasting Control Channel (BCCH). The UTRAN will receive updated registration information from the UE (step S102). If the user has already subscribed multi-hop communication services, the user can set (or preset) an operating mode for the multi-hop communication services as either a default mode or a prompt mode. In the default mode, when the UE originates a call, the multi-hop communication services are automatically selected as a first choice for communication. On the other hand, in the prompt mode, when the UE originates a call, the UE will receive a prompt from the UTRAN for selecting the multi-hop communication services. Each of the two modes may be set for a specific time duration.

When the UE originates a call, it first sends a request to the UTRAN to initiate the call. The request may include a multi-hop connect request. After receiving the request to initiate the call (step S106), the UTRAN may also automatically attempt to set up a multi-hop communication link between the originating UE and itself, regardless of whether there is a multi-hop connect request from the UE. The UTRAN will first check whether the UE has subscribed the mutli-hop communication services (step S108). Then, the UTRAN determines whether the UE is suitable for using the multi-hop communication services (step S112). If the UE is not suitable because of, for example, the UE is not within a multi-hop communication supported radio range or one of the communicating UEs is moving at a high speed, then the UTRAN will provide the conventional communication services to the UE (step 114).

On the other hand, if the UE is suitable for using the multi-hop communication services, the UTRAN will determine whether the UE is in a default or prompt mode for the multi-hop communication services (step S116). If the UE is in the prompt mode, the UTRAN sends a prompt to the UE, along with information about the incentive to encourage the user to use the multi-hop communication services (step S122). The incentive may be in the form of a discount, a rebate or promotional coupons, and include information about battery savings as a result of using multi-hop communication services. The discount may be calculated based on the statistical benefits resulting from the system capacity increase and the overall interference decrease. The discount rate may also be calculated based on the number of hops supporting the communication link. The more the number of hops is used, the more the system capacity is increased. Additionally, the discount rate may vary in accordance with the actual traffic load conditions or the interference during a predetermined time duration. For example, if the traffic load is very heavy, the discount rate for the multi-hop communication services may be higher.

After the UTRAN receives a selection from the UE (step S126), it determines whether the UE has selected the multi-hop communication services (step S132). If the UE fails to select the multi-hop communication services because of the QoS (Quality of Service) concerns in the case of an important call for example, the UTRAN will provide the UE with the conventional communication services (step S114). On the other hand, if the UE has selected the multi-hop communication services or the UE is already in the default mode for using the multi-hop communication services, the UTRAN will determine whether multi-hop relaying by other UEs is available for completing the call (step S134) and send information about incentive for providing relaying to the available UEs. If relaying is not available, the UTRAN will provide the conventional communication services to the UE (step S114). Otherwise, the UTRAN allocates resources to the originating and relaying UEs to allow the UE to start the multi-hop communication with the UTRAN (step S136).

After the multi-hop communication is completed and the multi-hop communication resources are released, the UTRAN records the information relating to the multi-hop communication services for both the originating and relaying UEs in a Home Location Register (HLR) or a Visitor Location Register (VLR) (step S142). The UTRAN also sends the discounted billing information to the originating UE and incentive information to the relaying UEs to allow the users to immediately view the information (step S146).

The UTRAN performs steps similar to those in FIG. 2 for determining whether multi-hop communication services should be provided to a receiving UE.

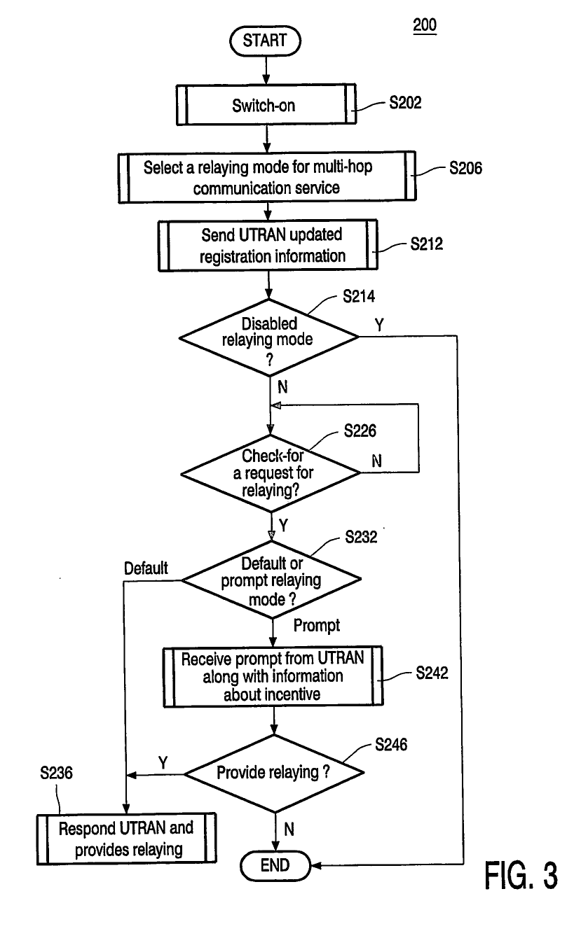

FIG. 3 illustrates a process 200 performed by a UE for providing relaying to another UE in multi-hop communication, according to one embodiment of the invention. The various steps of process 200 are preferably implemented with software modules.

After a user has switched on a UE (step S202), the UE searches in a cell for signals from the UTRAN, via a Broadcasting Control Channel (BCCH). The user can set (or preset) a relaying mode as a default relaying mode, a prompt relaying mode or a disabled relaying mode for providing relaying to other UEs in multi-hop communications (step S206). In the default relaying mode, the UE automatically provides relaying services upon receiving a request from the UTRAN. In the prompt relaying mode, however, the UE will receive a prompt from the UTRAN for deciding whether or not to provide relaying services. In the disabled relaying mode, the UE is disabled from providing relaying services. Each of these three relaying modes can be set for a predetermined time duration.

Then the UE sends updated registration information to the UTRAN, including information about whether the UE is in a virtual switched-off mode or an idle mode (step S212). In the virtual switched-off mode, the UE is powered on but cannot originate or receive calls, and the network can make use of the UE for relaying in multi-hop communication without the user's knowledge. Thus, a mobile user can have the UE turned off (e.g., during sleeping), but the UE can be used for providing relaying services in multi-hop communications and earn money for the user. In the idle mode, the UE can originate and receive calls, and provide relaying for multi-hop communications.

The UE checks whether itself is in a disabled relaying mode (step S214). If it is in the disabled mode, the UE rejects all requests for relaying services. If it is not in a disabled relaying mode, the UE checks to see if there is a request for relaying (step S226). If no request is received, the UE determines whether itself is in a default relaying mode or a prompt relaying mode (step S232). If it is in the default relaying mode, the UE responds to the UTRAN and provides relaying as requested (step S236). On the other hand, if the UE is in the prompt relaying mode, the UE receives a prompt from the UTRAN (step S242), along with information about incentive for providing relaying. The incentive may be in the form of redeemable points based on the time duration during which the relaying is provided. The UE then determines whether the user has chosen to provide relaying in multi-hop communication (step S246). If so, the UE will respond to the UTRAN and provide relaying as requested (step S236).

In the case of an emergency call that may be indicated by a special signal, forwarding the emergency call should be mandatory and default for all mobile terminals that have subscribed multi-hop communication services as users or registered for providing relaying services in multi-hop communications. The wireless communication system will process emergency calls on a first-come-first-serve basis.

In FIGS. 2 and 3 above, the various steps may be implemented with software modules or a combination of software and hardware modules. In a preferred embodiment of the invention, the hardware of the existing UTRAN and UEs remains unchanged, while the various steps in FIGS. 2 and 3 are all implemented with software modules.

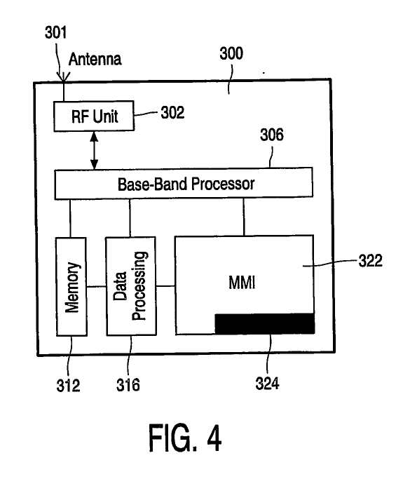

FIG. 4 illustrates basic components of a mobile terminal 300 in accordance with one embodiment of the invention. Mobile terminal 300 includes an antenna 301, a RF unit 302, a baseband processor 306, a memory 312, a data processing unit 316, and a man-machine interface (MMI) 322. MMI 322 is typically in the form of a menu on a display and includes a virtual switched-off indicator 324 that shows whether the virtual switched-off mode of mobile terminal 300 is activated.

In the above, the invention has been illustrated in conjunction with a UTRAN. However, it is not limited to the UTRAN. In fact, any wireless network system may be used in conjunction with the present invention.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method performed by a wireless communication system for managing multi-hop communications, the method comprising the steps of:
(a) receiving a request from an originating mobile terminal for initiating a call to a receiving mobile terminal;
(b) determining whether the originating mobile terminal can use multi-hop communication services;
(c) determining an operating mode of the originating mobile terminal for multi-hop communication;
(d) determining whether relaying can be provided by one or more relaying mobile terminals for multi-hop communication by the originating mobile terminal; and
(e) if the originating mobile terminal can use the services, the originating mobile terminal is in the default mode, and the relaying can be provided, establishing multi-hop communication between the originating mobile terminal and the system.

2. The method of claim 1, wherein step (b) includes the steps of:
(i) determining whether the originating mobile terminal has subscribed multi-hop communication services; and
(ii) if the originating mobile terminal has subscribed the multi-hop communication services, determining whether the originating mobile terminal is suitable for using the multi-hop communication services.

3. The method of claim 1, further comprising the step of:
if the originating mobile terminal is in a prompt mode for multi-hop communication, sending a prompt to the originating mobile terminal for selection of the multi-hop communication services, along with information about incentives for using the services.

4. The method of claim 3, wherein step (e) includes the step of:
if the originating mobile terminal in the prompt mode selects the multi-hop communication services, allocating resources for setting up a multi-hop communication link between the originating mobile terminal and the system.

5. The method of claim 1, further comprising the step of:
after the multi-hop communication is completed, recording information relating to the multi-hop communication services for the originating and relaying mobile terminals in at least one of a home location register and a visitor location register.

6. The method of claim 5, further comprising the step of:
after the multi-hop communication is completed, sending discounted billing information to the originating mobile terminal and incentive information to the relaying mobile terminals.

7. The method of claim 3, further comprising the step of providing conventional communication services to the originating mobile terminal, if the originating mobile terminal cannot use multi-hop communication services, the relaying cannot be provided, or the originating mobile terminal in the prompt mode fails to select the multi-hop communication services.

8. The method of claim 3, further comprising the step of calculating the incentives to the originating mobile terminal based on statistical benefits resulting from at least one of an increase in system capacity and an decrease in overall interference.

9. The method of claim 3, further comprising the step of calculating the incentives to the originating mobile terminal based on the number of hops used to support the multi-hop communication link.

10. The method of claim 3, further comprising the step of calculating the incentives to the originating mobile terminal in accordance with actual traffic load conditions and interference for a predetermined time duration.

11. A method performed by a wireless communication system in response to a request from an originating mobile terminal for initiating a call to a receiving mobile terminal, the method comprising the steps of:
(a) determining whether the receiving mobile terminal can use multi-hop communication services;
(b) determining an operating mode of the receiving mobile terminal for multi-hop communication;
(c) determining whether relaying can be provided by one or more relaying mobile terminals for multi-hop communication by the receiving mobile terminal; and
(d) if the receiving mobile terminal can use the services, the receiving mobile terminal is in the default mode, and the relaying can be provided, establishing multi-hop communication between the receiving mobile terminal and the system.

12. The method of claim 11, wherein step (a) includes the steps of:
(i) determining whether the receiving mobile terminal has subscribed multi-hop communication services; and
(ii) if the receiving mobile terminal has subscribed the multi-hop communication services, determining whether the receiving mobile terminal is suitable for using the multi-hop communication services.

13. The method of claim 11, further comprising the step of:
if the receiving mobile terminal is in a prompt mode for multi-hop communication, sending a prompt to the receiving mobile terminal for selection of the multi-hop communication services, along with information about incentives for using the services.

14. The method of claim 13, wherein step (d) includes the step of:
if the receiving mobile terminal in the prompt mode selects the multi-hop communication services, allocating resources for setting up a multi-hop communication link between the receiving mobile terminal and the system.

15. The method of claim 11, further comprising the step of:
after the multi-hop communication is completed, recording information relating to the multi-hop communication services for the receiving and relaying mobile terminals in at least one of a home location register and a visitor location register.

16. The method of claim 15, further comprising the step of:
after the multi-hop communication is completed, sending discounted billing information to the receiving mobile terminal and incentive information to the relaying mobile terminals.

17. The method of claim 13, further comprising the step of providing conventional communication services to the receiving mobile terminal, if the receiving mobile terminal cannot use multi-hop communication services, the relaying cannot be provided, or the receiving mobile terminal in the prompt mode fails to select the multi-hop communication services.

18. The method of claim 13, further comprising the step of calculating the incentives to the receiving mobile terminal based on statistical benefits resulting from at least one of an increase in system capacity and an decrease in overall interference.

19. The method of claim 13, further comprising the step of calculating the incentives to the receiving mobile terminal based on the number of hops used to support the multi-hop communication link.

20. The method of claim 13, further comprising the step of calculating the incentives to the receiving mobile terminal in accordance with actual traffic load conditions and interference for a predetermined time duration.

21. A method performed by a mobile terminal, comprising the steps of:
(a) checking whether there is a request from a wireless communication system for providing relaying in multi-hop communication;
(b) if there is a request for relaying, determining a relaying mode of the mobile terminal for multi-hop communication;
(c) if the mobile terminal is in a prompt relaying mode, checking whether a prompt for relaying has been received from the wireless communication system;
(d) if the prompt has been received, determining whether a user of the mobile terminal has chosen to provide relaying; and
(e) if the user has chosen to provide the relaying, providing the relaying.

22. The method of claim 21, further comprising the step of, if the mobile terminal is in a default mode, providing the relaying.

23. The method of claim 21, further comprising the step of, before step (a), checking whether the mobile terminal is in an idle mode; and wherein step (a) is performed if the mobile terminal is in an idle mode.

24. The method of claim 21, further comprising the steps of:
before step (a) determining whether the mobile terminal is in a disabled relaying mode; and
if the mobile terminal is in the disabled relaying mode, rejecting any request for relaying.

25. A wireless communication system capable of managing multi-hop communications, comprising:
means for receiving a request from an originating mobile terminal for initiating a call to a receiving mobile terminal;
means for determining whether the originating mobile terminal can use multi-hop communication services;
means for determining an operating mode of the originating mobile terminal for multi-hop communication;
means for determining whether relaying can be provided by one or more relaying mobile terminals for multi-hop communication by the originating mobile terminal; and
means for establishing multi-hop communication between the originating mobile terminal and the system;
wherein the establishing means establishes the multi-hop communication if the originating mobile terminal can use the services, the originating mobile terminal is in the default mode, and the relaying can be provided.

26. The system of claim 25, wherein whether the originating mobile terminal can use multi-hop communication services is determined based on whether the originating mobile terminal has subscribed multi-hop communication services and whether the originating mobile terminal is suitable for using the multi-hop communication services.

27. The system of claim 25, further comprising means for sending; wherein if the originating mobile terminal is in a prompt mode for multi-hop communication, the sending means sends a prompt to the originating mobile terminal for selection of the multi-hop communication services, along with information about incentives for using the services.

28. The system of claim 27, wherein the establishing means includes means for allocating resources, and wherein if the originating mobile terminal in the prompt mode selects the multi-hop communication services, the allocating means allocates resources for setting up a multi-hop communication link between the originating mobile terminal and the system.

29. The system of claim 25, further comprising means for recording; wherein after the multi-hop communication is completed, the recording means records information relating to the multi-hop communication services for the originating and relaying mobile terminals in at least one of a home location register and a visitor location register.

30. The system of claim 27, wherein after the multi-hop communication is completed, the sending means sends discounted billing information to the originating mobile terminal and incentive information to the relaying mobile terminals.

31. The system of claim 27, further comprising means for calculating the incentives to the originating mobile terminal based on statistical benefits resulting from at least one of an increase in system capacity and an decrease in overall interference.

32. The system of claim 27, further comprising means for calculating the incentives to the originating mobile terminal based on the number of hops used to support the multi-hop communication link.

33. The system of claim 25, wherein the three determining means respectively determines:
whether the receiving mobile terminal can use multi-hop communication services;
an operating mode of the receiving mobile terminal for multi-hop communication; and
whether relaying can be provided by one or more relaying mobile terminals for multi-hop communication by the receiving mobile terminal; and
wherein the establishing means establishes the multi-hop communication between the receiving mobile terminal and the system if the receiving mobile terminal can use the services, the receiving mobile terminal is in the default mode, and the relaying can be provided.
